(19) United States
(12) Patent Application Publication
(10) Pub. No.: US 2008/0008476 A1
(43) Pub. Date: Jan. 10, 2008

(54) Optical transmitting/receiving apparatus and optical transmitting/receiving method

(75) Inventor: Hiroshi Yamamoto, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 11/819,661

(22) Filed: Jun. 28, 2007

(30) Foreign Application Priority Data
Jul. 4, 2006 (JP) 2006-184835
Jun. 20, 2007 (JP) 2007-162179

(51) Int. Cl. H04B 10/04

(52) U.S. Cl. 398/135

(57) ABSTRACT

It is to enable control of an optical transceiver through radio communication. The optical transmitting/receiving apparatus comprises: an optical transceiver which transmits and receives an optical signal to/from outside via an optical fiber; a control device for controlling the optical transceiver; and a main signal wiring system and a control wiring system, which are formed between the optical transceiver and the control device. The main signal wiring system is constituted with a wired circuit for transmitting a main signal that is an electric signal converted mutually with the optical signal. The control wiring system is constituted with a radio circuit for mutually transmitting a monitoring signal that is outputted from the optical transceiver and a control signal that is outputted from the control device based on the monitoring signal for controlling the optical transceiver.

### BACKGROUND OF THE INVENTION

1. Field of the Invention

This application is based upon and claims the benefit of priority from Japanese patent application No. 2006-184835, filed on Jul. 4, 2006, the disclosure of which is incorporated herein in its entirety by reference.

The present invention relates to an optical transmitting/receiving apparatus and an optical transmitting/receiving method, which are used for optical fiber communication.

2. Description of the Related Art

An optical transceiver is provided as a data input/output port of a control device of a communication apparatus, a network apparatus, a computer, a storage device, or the like, so as to enable optical data communication through connecting the optical communication network and the control device and executing conversion of optical signals and electric signals. Recently, the optical transceiver has been required to reduce the size and increase the density. One of the reasons for this is that the physical size thereof is determined on the basis of MSA (Multi Source Agreement). Regardless of such demands and restrictions, there is more demand to increase the functions of the optical transceiver. Accordingly, there is an increase in the number of control terminals.

However, when the control terminals are increased, the number of wirings connected to the control terminals in the optical transceiver is naturally increased. Thus, the wirings on a printed board that constitutes the optical transceiver become extremely dense. Therefore, it is difficult to align the impedance and to execute stable communication (for example, waveform of a data signal transmitted/received between apparatuses becomes deteriorated due to the noise of an electromagnetic wave and the like from the wirings).

In view of this point, Japanese Unexamined Patent Publication 2003-198464 (Patent Document 1) discloses an optical transceiver that is constituted to perform radio communication with an apparatus without using a connector for inputting and outputting electric signals to/from the apparatus.

Recently, in accordance with the developments in the data communication technology, the signal transmission speed between an optical transceiver and an apparatus is assumed to be in a high frequency of 1 GHz or more. It has become difficult to maintain the property under transmission with such high frequency. It is still difficult to do so even with the use of the optical transceiver disclosed in Patent Document 1, and it is desired to improve the technique further.

### SUMMARY OF THE INVENTION

An exemplary object of the present invention therefore is to provide an optical transmitting/receiving apparatus and an optical transmitting/receiving method with which control of an optical transceiver can be performed with radio communication.

In order to achieve the foregoing object, as an exemplary aspect of the invention, the optical transmitting/receiving apparatus comprises:

an optical transceiver which transmits and receives an optical signal to/from outside via an optical fiber;

a control device for controlling the optical transceiver; and

a main signal wiring system and a control wiring system, which are formed between the optical transceiver and the control device, wherein:

the main signal wiring system is constituted with a wired circuit for transmitting a main signal that is an electric signal converted mutually with the optical signal; and

the control wiring system is constituted with a radio circuit for mutually transmitting a monitoring signal that is outputted from the optical transceiver and a control signal that is outputted from the control device based on the monitoring signal for controlling the optical transceiver.

In the description provided above, the present invention is constituted as an optical transmitting/receiving apparatus. However, the present invention is not limited to that but may be constituted as an optical transmitting/receiving method as well.

As another exemplary aspect of the invention, the optical transmitting/receiving method:

forms two types of wiring systems, that is, a main signal wiring system constituted with a wired circuit and a control wiring system constituted with a radio circuit, between an optical transceiver for transmitting/receiving an optical signal to/from outside via an optical fiber and a control device for controlling the optical transceiver;

transmits a main signal that is an electric signal converted mutually with the optical signal, by using the main signal wiring system that is constituted with the wired circuit; and

transmits a monitoring signal that is outputted from the optical transceiver and a control signal that is outputted from the control device for controlling the optical transceiver based on the monitoring signal, by using the control wiring system that is constituted with the radio circuit.

With the present invention, the data communication circuit between the outside and the control device can be formed as a wired circuit, and the circuit for receiving the control instruction signals from the control device can be formed as a radio communication circuit. With this, it is possible to reduce the wirings on the printed board within the optical transceiver, while securing the transmission path that can correspond to the high transmission speed with respect to the control device through the wired line.

### BRIEF DESCRIPTION OF THE DRAWINGS

FIG. 1 is a block diagram for showing the structure of a first exemplary embodiment according to the present invention;

FIG. 2 is a flowchart for showing the operation of a memory control circuit that is disclosed in the exemplary embodiment shown in FIG. 1;

FIG. 3 is a block diagram for showing the structure of a second exemplary embodiment according to the present invention; and

FIG. 4 is a block diagram for showing the structure of a second exemplary embodiment according to the present invention.

### DETAILED DESCRIPTION OF THE EXEMPLARY EMBODIMENTS

Exemplary embodiment of the present invention will be described hereinafter by referring to the accompanying drawings.

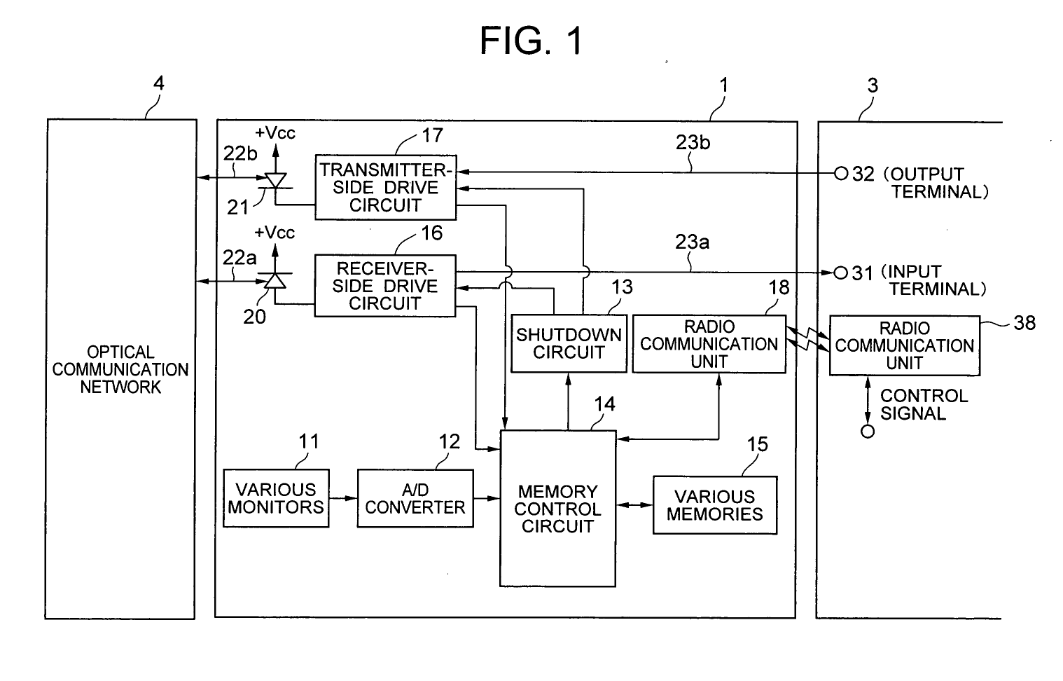

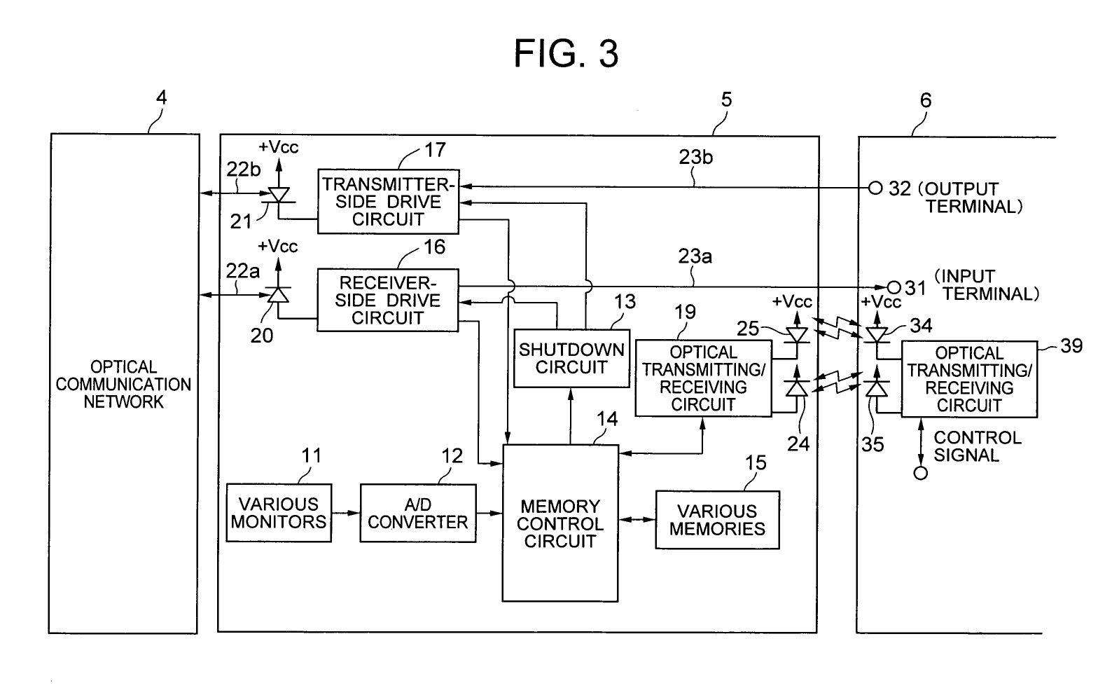

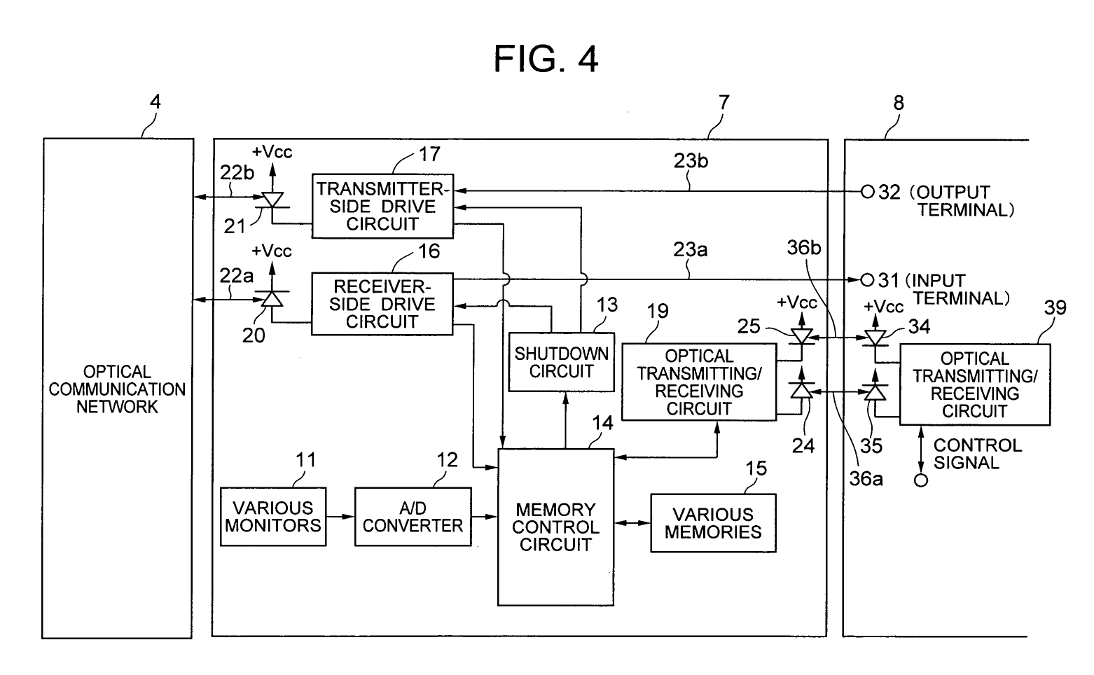

As shown in FIG. 1, FIG. 3 and FIG. 4, optical transmitting/receiving apparatuses according to the exemplary embodiments of the present invention comprise: an optical transceiver 1 which transmits/receives optical signals to/from the outside through optical fibers 22a, 22b; a control device 3 for controlling the optical transceiver 1; and a main signal wiring system (23a, 23b) and a control wiring system (18, 38, 19, 39) formed between the optical transceiver land the control device 3. The main signal wiring system (23a, 23b) is used for transmitting main signals that are electric signals mutually converted with the optical signals, and it is constituted with a wired circuit. The control wiring system (18, 38, 19, 39) is used for mutually transmitting monitoring signals outputted from the optical transceiver 1 and control signals that are outputted from the control device 3 for controlling the optical transceiver based upon the monitoring signals, and it is constituted with a radio circuit.

For performing optical transmission/reception by using the optical transmitting/receiving apparatus according to the present invention, the main signals that are electric signals mutually converted with the optical signals are transmitted by using the main signal wiring system that is constituted with the wired circuit. Meanwhile, the monitoring signals outputted from the optical transceiver and the control signals that are outputted from the control device for controlling the optical transceiver based upon the monitoring signals are transmitted by using the control wiring system that is constituted with the radio circuit.

With the exemplary embodiment of the present invention, it is possible to provide the data communication circuit between the outside and the control device with a wired circuit, and the circuit for receiving the control instruction signals from the control device with the radio communication line. Therefore, it is possible to reduce the wirings on the printed board within the optical transceiver, while keeping the transmission path capable of dealing with the high transmission speed with the control device through the wired circuit.

Next, the optical transmitting/receiving apparatus according to the invention will be described by referring to the exemplary embodiments.

### First Exemplary Embodiment

FIG. 1 is a block diagram for showing the structure of an optical transmitting/receiving apparatus according to a first exemplary embodiment of the present invention.

As shown in FIG. 1, the optical transmitting/receiving apparatus according to the first exemplary embodiment of the present invention comprises: an optical transceiver 1 which transmits/receives optical signals to/from the outside through optical fibers 22a, 22b; a control device 3 for controlling the optical transceiver 1; and a main signal wiring system 23a, 23b and a control wiring system 18, 38 formed between the optical transceiver 1 and the control device 3.

The optical transceiver 1 is connected to an optical communication network 4 through the optical fibers 22a, 22b, and to the control device 3 through wired lines 23a, 23b which transmit high-frequency electric signals. The high-frequency electric signal means the main signal that is the electric signal to be mutually converted with the optical signal. Further, the wired lines 23a, 23b are wirings for transmitting the main signal that is the electric signal to be mutually converted with the optical signal, and it means the main signal wiring system that is constituted with the wired circuit.

Further, the optical transceiver 1 comprises: transmitting/receiving drive circuits 16, 17 which perform optical fiber communication through mutually converting the optical signals and the electric signals; and a monitoring device for monitoring the state of the optical transceiver 1 including the transmitting/receiving drive circuits 16, 17.

The monitoring device comprises: various monitors 11 for monitoring the state of power supply and temperatures; an A/D converter 12 for converting analog signals to digital signals; a shutdown circuit 13 as a switching device for switching connection and disconnection states of the communication circuits for the control device 3; a memory control circuit 14 for controlling the processing operation of the shutdown circuit 13; and various memories 15 as information recording media such as a RAM and a hard disk device.

The receiver-side drive circuit 16 comprises a PD (photodiode) 20 as a light-receiving element which receives an optical signal from the optical fiber 22a via the optical communication network 4 and converts it to an electric signal, and sends out the electric signal from the PD 20 to the control device 3 as the reception data. The transmitter-side drive circuit 17 has a function to work as a transmission data input device for inputting the electric signal (main signal) from the control device 3 as the transmission data. The transmitter-side drive circuit 17 converts the transmission data to an optical signal by using an LD (laser diode) 21 as a light-emitting device, and emits it to the optical fiber 22b.

The optical transceiver 1 comprises a radio communication unit 18, and the control device 3 comprises a radio communication unit 38. The radio communication unit 18 and the radio communication unit 38 constitute the control wiring system. The control wiring system constituted with the radio communication unit 18 and the radio communication unit 38 mutually transmits a monitoring signal that is outputted from the optical transceiver 1 and a control signal that is outputted from the control device 3 for controlling the optical transceiver 1 based upon the monitoring signal. The control wiring system is structured as a radio circuit.

The various monitors 11 are constituted with a temperature detection monitor, a voltage detection monitor, an electric current detection monitor, an optical output detection monitor, and the like, which function as monitoring devices to monitor the temperature within the optical transceiver 1, changes in the voltage applied to the wired lines 23a, 23b, changes in the electric current flown in the wired lines 23a, 23b, emitted light level that is outputted to the PD 20, etc., to detect the respective values and generate monitoring signals (constituted with analog signals) based on those values. The various monitors 11 output the monitoring signals to the A/D converter 12 at certain cycles.

The A/D converter 12 converts the analog signals from the various monitors 11 into digital signals, and outputs the monitoring signals that are constituted with the digital signals to the memory control circuit 14.

The shutdown circuit 13 switches connection and disconnections states of the communication circuit between the receiver-side drive circuit 16, the transmitter-side drive circuit 17, and the control device 3. For example, when an on-signal is inputted from the memory control circuit 14, the shutdown circuit 13 outputs a signal to the receiver-side drive circuit 16 for permitting the output of the data signal to the control device 3. When an off-signal is inputted from the memory control circuit 14, the shutdown circuit 13 outputs a signal to the receiver-side drive circuit 16 for halting the output of the data signal to the control device 3. Further, when an on-signal is inputted from the memory control circuit 14, the shutdown circuit 13 outputs a signal to the transmitter-side drive circuit 17 for permitting the output of the data signal inputted from the control device 3 to the LD 21. When an off-signal is inputted from the memory control circuit 14, the shutdown circuit 13 outputs a signal to the transmitter-side drive circuit 17 for halting the output of the data signal inputted from the control device 3 to the LD 21.

The memory control circuit 14 monitors the monitoring signals that are outputted from the various monitors 11 at certain cycles, and stores the monitoring signals from the A/D converter 12 to the various memories 15.

The receiver-side drive circuit 16 has a function to work as an alarm signal emitting device which: detects changes in the electric current or the voltage within the receiver-side drive circuit 16 itself; produces an alarm signal when the detected current or the voltage reaches a current change reference value or a voltage change reference value stored in the various memories 15; and outputs the alarm signal to the memory control circuit 14. Further, the receiver-side drive circuit 16 executes or stops transmission of the reception data to the control device 3 in accordance with the signal from the shutdown circuit 13. The receiver-side drive circuit 16 that functions as the alarm signal emitting device constitutes a part of the monitoring device described above.

The transmitter-side drive circuit 17 has a function to work as an alarm signal emitting device which: detects changes in the electric current or the voltage within the transmitter-side drive circuit 17 itself; produces an alarm signal when the detected current or the voltage reaches a current change reference value or a voltage change reference value stored in the various memories 15; and outputs the alarm signal to the memory control circuit 14. Further, the transmitter-side drive circuit 17 executes or stops output of transmission data to LD 21 in accordance with the signal from the shutdown circuit 13. The transmitter-side drive circuit 17 that functions as the alarm signal emitting device constitutes a part of the monitoring device.

Further, the memory control circuit 14 stores the alarm signals that are inputted from the receiver-side drive circuit 16 or the transmitter-side drive circuit 17 into the various memories 15, reads out the monitoring signal or the alarm signal from the various memories 15, and outputs the monitoring signal or the alarm signal to the radio communication unit 18.

The radio communication unit 18 has a function to work as a monitoring signal transmitting device and an alarm signal transmitting device for transmitting the monitoring signal or the alarm signal to the control device 3. Further, the radio communication unit 18 has a function to work as a control instruction signal input device for inputting a control instruction signal from the control device 3 to give an instruction for controlling the operation of the optical transceiver 1. Used as the system for the radio communication in the radio communication unit 18 may be selected from Bluetooth, NFC (Near Field Communication), UWB (Ultra Wide Band), ZigBee, etc.

Further, the memory control circuit 14 outputs an on-signal or an off-signal to the shutdown circuit 13 based on the control instruction signal from the radio communication unit 18.

The various memories 15 store the monitoring signal and the alarm signal. Further, the various memories 15 store a reference value that is the reference for the receiver-side drive circuit 16 or the transmitter-side drive circuit 17 to emit the alarm signal. For this reference value, there are a current change reference value for the changes in the electric current, and a voltage change reference value for the changes in the voltage.

This exemplary embodiment is so constituted that the receiver-side drive circuit 16 or the transmitter-side drive circuit 17 detects the changes in the electric current or the voltage, and emits the alarm signal when the detected value of the electric current or the voltage reaches the current change reference value or the voltage change reference value that is stored in the various memories 15. However, the structure is not limited to that. For example, the exemplary embodiment may be structured in such a manner that the memory control circuit 14 collates the value of the voltage applied to the wired lines 23a, 23b or the value of the electric current flown in the wired lines 23a, 23b (detected by the various monitors 11) with the current change reference value or the voltage change reference value that is stored in the various memories 15, and emits the alarm signal when the detected value of the electric current or the voltage reaches the current change reference value or the voltage change reference value.

Next, the operation of the optical transmitting/receiving apparatus will be described.

(1) Described is an operation when the reception data that is received from the outside is transmitted to the control device 3.

When a reception data signal constituted with an optical signal is inputted to the PD 20 from the optical communication network 4 via the optical fiber 22a, the PD 20 converts the reception data signal constituted with the optical signal into a reception data signal constituted with an electric signal, and outputs the reception data signal to the receiver-side drive circuit 16.

The receiver-side drive circuit 16 amplifies the reception data signal (constituted with the electric signal) from the PD 20, and outputs the amplified reception data signal to the control device 3 via the wired line 23a.

(2) Described is an operation when the transmission data from the control device is transmitted to the optical communication network 4.

The transmitter-side drive circuit 17 outputs the transmission data signal constituted with a high-frequency electric signal, which is inputted from the control device 3 via the wired line 23b, to the LD 21. The LD 21 converts the transmission data signal (constituted with an electric signal) from the transmitter-side drive circuit 17 to an optical signal, and transmits the optical signal to the optical communication network 4 via the optical fiber 22b.

(3) Described is an operation when an alarm signal from the receiver-side drive circuit 16 or the transmitter-side drive circuit 17 is inputted to the memory control circuit 14.

The receiver-side drive circuit 16 successively detects changes in the electric current or the voltage of the amplified reception data signal, and outputs the alarm signal to the memory control circuit 14 when the detected value of the electric current or the voltage reaches the current change reference value or the voltage change reference value stored in the various memories.

The transmitter-side drive circuit 17 detects changes in the electric current or the voltage of the transmission data signal, and outputs the alarm signal to the memory control circuit 14 when the detected value of the electric current or the voltage reaches the current change reference value or the voltage change reference value stored in the various memories 15. The memory control circuit 14 stores the alarm signal that is inputted from the receiver-side drive circuit 16 or the transmitter-side drive circuit 17 to the various memories 15, and ends the processing thereafter.

(4) Described is an operation from generation of monitoring signals by the various monitors 11 to the transmission of the monitoring signals or the alarm signals to the control device 3.

First, in accordance with the changes in the temperature, voltage, electric current, emission light level or the like of the optical transceiver 1, the various monitors 11 output the monitoring signals in real-time (constituted with analog signals) that show the detail of the changes to the A/D converter 12 (monitoring step).

The A/D converter 12 converts the analog signals that are inputted from the various monitors 11 into digital signals, and outputs the signals to the memory control circuit 14 as the monitoring signals.

The memory control circuit 14 monitors the monitoring signals that are outputted from the various monitors 11 at certain cycles, and stores the monitoring signals from the A/D converter 12 to the various memories 15.

Thereafter, the memory control circuit 14 outputs the monitoring signals stored in the various memories 15 or the alarm signal to the radio communication unit 18. The radio communication unit 18 transmits the monitoring signals or the alarm signal from the memory control circuit 14 to the radio communication unit 38 of the control device 3 via the radio communication circuit, and ends the processing (monitoring signal transmission step).

In this manner described above, the control device 3 that has received the monitoring signals or the alarm signal adjusts the control instruction signal based on the monitoring signals or the alarm signal, and the control instruction signal is transmitted from the radio communication unit 38.

For the monitoring signal transmission step described above, the contents thereof may be put into a program for allowing a computer that controls the optical transceiver 1 to execute it as monitoring signal transmission processing.

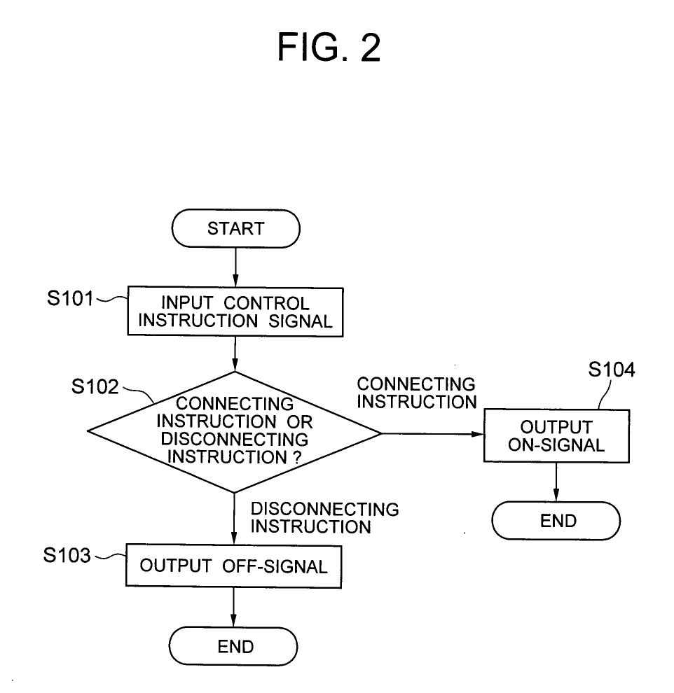

(5) Described herein are operations when the receiver-side drive circuit 16 stops the output of the reception data signal to the control device 3, and when the transmitter-side drive circuit 17 stops the output of the transmission data signal to the LD 21. Further, the operation of the memory control circuit 14 at that time is described by referring to FIG. 2.

When the radio communication unit 18 receives, from the radio communication unit 38 of the control device 3 through the radio communication circuit, a control instruction signal that gives an instruction to control the receiver-side drive circuit 16 to stop the output of the reception data signal to the control device 3 and an instruction to control the transmitter-side drive circuit 17 to stop the output of the transmission data signal to the LD 21, the radio communication unit 18 outputs the control instruction signal to the memory control circuit 14.

Upon receiving an input of the control instruction signal (control instruction signal input step, FIG. 2: step S101), the memory control circuit 14 outputs an off-signal to the shutdown circuit 13 to give the instructions for the receiver-side drive circuit 16 to stop the output of the reception data signal to the control device 3 and for the transmitter-side drive circuit 17 to stop the output of the transmission data signal to the LD 21 (FIG. 2: step S103).

Upon receiving an input of the off-signal from the memory control circuit 14, the shutdown circuit 13 outputs an instruction to the receiver-side drive circuit 16 to stop the output of the reception data signal to the control device 3, and outputs a request to the transmitter-side drive circuit 17 to stop the output of the transmission data signal to the LD 21.

Subsequently, the receiver-side drive circuit 16 switches the circuit for transmitting the electric signals from the optical communication network 4 to the control device 3 into a disconnected state so as to stop the output of the reception data signal to the control device 3, while the transmitter-side drive circuit 17 switches the circuit for transmitting the electric signals from the control device 3 to the optical communication network 4 into a disconnected state so as to stop the output of the transmission data signal to the LD 21, and ends the processing (switching step).

(6) Described herein are operations when the receiver-side drive circuit 16 permits the output of the reception data signal to the control device 3, and when the transmitter-side drive circuit 17 permits the output of the transmission data signal to the LD 21. Further, the operation of the memory control circuit 14 at that time is described by referring to FIG. 2.

When the radio communication unit 18 receives, from the radio communication unit 38 of the control device 3 through the radio communication circuit, a control instruction signal that gives an instruction to control the receiver-side drive circuit 16 to permit the output of the reception data signal to the control device 3 and an instruction to control the transmitter-side drive circuit 17 to permit the output of the transmission data signal to the LD 21, the radio communication unit 18 outputs the control instruction signal to the memory control circuit 14.

Upon receiving an input of the control instruction signal (control instruction signal input step, FIG. 2: step S101), the memory control circuit 14 outputs an on-signal to the shutdown circuit 13 to give the instructions for the receiver-side drive circuit 16 to permit the output of the reception data signal to the control device 3 and for the transmitter-side drive circuit 17 to permit the output of the transmission data signal to the LD 21 (FIG. 2: step S104).

Upon receiving an input of the on-signal from the memory control circuit 14, the shutdown circuit 13 outputs an instruction to the receiver-side drive circuit 16 to permit the output of the reception data signal to the control device 3, and outputs an instruction to the transmitter-side drive circuit 17 to permit the output of the transmission data signal to the LD 21.

Subsequently, the receiver-side drive circuit 16 switches the circuit for transmitting the electric signals from the optical communication network 4 to the control device 3 into a connected state so as to restart the output of the reception data signal to the control device 3, while the transmitter-side drive circuit 17 switches the circuit for transmitting the electric signals from the control device 3 to the optical communication network 4 into a connected state so as to restart the output of the transmission data signal to the LD 21, and ends the processing (switching step).

For the control instruction signal input step described above, the contents thereof may be put into a program for allowing the computer that controls the optical transceiver 1 to execute it as control instruction signal input processing. Further, for the above-described operations of the memory control circuit 14 to output the on-signal or the off-signal to the shutdown circuit 13, the contents thereof may be put into a program for allowing the computer that controls the optical transceiver 1 to execute it as connection/disconnection switching processing.

With the first exemplary embodiment described above, the signals regarding the control of the optical transceiver 1 such as the monitoring signals, the alarm signals, and the control instruction signals can be transmitted/received through the radio communication. Thus, the wirings on the printed board loaded on the optical transceiver 1 can be reduced. Further, reduction of the wirings on the printed board results in reducing the drawing of the wirings that are used for the reception data signal and for the transmission data signal on the printed board. Therefore, impedance alignment can be performed easily and a wide area can be provided for grounding.

Further, reduction of the wirings on the printed board allows reduction in the size of the printed board and the like, thereby enabling the size of the optical transceiver itself to be reduced. Further, since the wirings between the optical transceiver 1 and the control device 3 are reduced, it is possible to reduce the noise of the electromagnetic waves that are required particularly when the reception data signal and the transmission data signal are high-frequency electric signals. Thus, the property of the optical transceiver can be improved.

Further, since the signals regarding the control of the optical transceiver are transmitted/received through radio communication between the optical transceiver 1 and the control device 3, an increase in the wirings can be suppressed even if other functions are added. Thus, expandability of the functions can be secured.

In the first exemplary embodiment, used as the transmission paths for the optical data communication between the optical communication network 4 and the control device 3 are wired lines, and used as the transmission paths for the signals regarding the control of the optical transceiver 1 for the operations of the optical transceiver 1 and the control device 3 are radio lines. Therefore, it is possible to prepare a device for controlling the optical transceiver 1 separately from the control device 3 so as to transmit/receive the signals regarding the control of the optical transceiver 1 between the device and the optical transceiver 1 through radio communication.

### Second Exemplary Embodiment

FIG. 3 is a block diagram for showing the structure of a second exemplary embodiment according to the present invention.

As shown in FIG. 3, an optical transceiver 5 of the second exemplary embodiment is connected to an optical communication network 4 via optical fibers 22a, 22b, and connected to a control device 6 via wired lines 23a, 23b which transmit high-frequency electric signals therebetween, as in the first exemplary embodiment.

Further, an optical transmitting/receiving apparatus of the second exemplary embodiment comprises various monitors 11, an A/D converter 12, a shutdown circuit 13, a memory control circuit 14, various memories 15, a receiver-side drive circuit 16, a transmitter-side drive circuit 17, a PD 20, and an LD 21, as the same structural elements as those of the optical transceiver 1 of the first exemplary embodiment.

The first exemplary embodiment uses electromagnetic waves for transmitting the signals through the radio communication circuit, while the second exemplary embodiment uses optical signals instead. That is, the second exemplary embodiment is provided with an optical transmitting/receiving circuit 19, a PD 24, an LD 25, an optical transmitting/receiving circuit 39, a PD 34, and an LD 35 for constituting a control wiring system that is constituted with the radio circuit.

The optical transmitting/receiving circuit 19 has a function to work as a monitoring signal transmission device and an alarm signal transmission device for transmitting the monitoring signal or the alarm signal to the control device 6 via the LD 25. Further, the optical transmitting/receiving circuit 19 has a function to work as a control instruction signal input device for inputting control instruction signals that are inputted from the control device 6 via the PD 24 to give an instruction on the operation control of the optical transceiver 5. The optical transmitting/receiving circuit 19 is a spatial transmission optical communication circuit which transmits/receives optical signals through the space, and IrDA (Infrared Data Association) that utilizes infrared rays may be used as the system of the optical communication.

The PD 24 is a light-receiving element which converts the control instruction signals (constituted with infrared rays to control the optical transceiver 5) that are outputted from the LD 35 of the control device 6 into electric signals, and outputs those to the optical transmitting/receiving circuit 19. The LD 25 is a light-emitting element which converts the monitoring signals and the alarm signal from the optical transmitting/receiving circuit 19 into infrared-ray optical signals, and transmits those to the PD 34 of the control device 6.

With the second exemplary embodiment, the control device 6 can control the optical transceiver 5 by utilizing infrared-ray communication through the use of the optical transmitting/receiving circuit 19, the PD 24, and the LD 25.

### Third Exemplary Embodiment

FIG. 4 is a block diagram for showing the structure of a third exemplary embodiment according to the present invention.

In the first exemplary embodiment shown in FIG. 1 and the second exemplary embodiment shown in FIG. 2, the control wiring system constituted with the radio circuit transmits the signals in free space by using the electromagnetic waves or the optical signals. However, instead of transmitting the signals in the free space, the control wiring system constituted with the radio circuit in the optical transmitting/receiving apparatus of the third exemplary embodiment that is shown in FIG. 4 transmits the signals through the optical fibers that are provided in free space.

Now, the differences between the control wiring system constituted with the radio circuit shown in FIG. 4 and the control wiring system shown in FIG. 3 will be described. As shown in FIG. 4, a PD 24 exchanges the optical signals with an LD 35 of a control device 8 via an optical fiber 36a, and an LD 25 exchanges the optical signals with a PD 34 of the control device 8 via an optical fiber 36b. With this, the optical transmitting/receiving circuit 19 comes to function as an optical communication circuit for transmitting and receiving the optical signals via the optical fibers.

According to this exemplary embodiment, with a combination of the PD 24, the LD 35 of the control device 8, and the optical fiber 36a, and a combination of the LD 25, the PD 34 of the control device 8, and the optical fiber 36b, it is possible to securely transmit/receive the control signals exchanged therebetween without being affected by radio waves.

Further, it is also possible to constitute the exemplary embodiment of the present invention in a following manner. That is, it maybe constituted with: a light-receiving element which receives an optical signal from the outside via an optical fiber and converts it into an electric signal; a reception data transmission device for transmitting the electric signal to a control device as the reception data; a transmission data input device for inputting the electric signal from the control device as the transmission data; a light-emitting element which converts the transmission data into an optical signal and emits it to the outside; and a control instruction signal input device for inputting a control instruction signal from the control device, which gives an instruction regarding the operation controls of the reception data transmission device and the transmission data input device, wherein the reception data transmission device and the transmission data input device have functions of inputting/outputting the signals with respect to the control device through a wired communication circuit, and the control instruction signal input device has a function of inputting the signals with respect to the control device through a radio communication circuit.

In such optical transceiver, the data communication circuit between the outside and the control device is formed as a wired communication circuit, and the circuit for receiving the control instruction signals from the control device is formed as a radio communication circuit. With such structure, it is possible to reduce the wirings on the printed board within the optical transceiver, while securing the transmission path that can correspond to the high transmission speed with respect to the control device through the wired line.

Further, reduction of the wirings on the printed board results in reducing the drawing of the wirings that are used for the reception data signal and for the transmission data signal on the printed board. Therefore, impedance alignment can be performed easily and a wide area can be provided for grounding. It is possible to reduce the noise of the electromagnetic waves that are required particularly when the reception data signal and the transmission data signal are high-frequency electric signals. Thus, the property of the optical transceiver can be improved.

Further, through separately providing the circuit for the data communication between the outside and the control device and the circuit for transmitting/receiving the information used for controlling the optical transceiver between the optical transceiver and the control device, load imposed upon each circuit can be lightened. Therefore, the communication speed can be improved.

Further, reduction of the wirings on the printed board allows reduction in the size of the printed board and the like. Accordingly, the size of the optical transceiver itself can be reduced.

Further, since the information for controlling the optical transceiver is transmitted/received between the optical transceiver and the control device, an increase in the wirings can be suppressed even if other functions are added. Thus, expandability of the functions can be secured.

The above-described optical transceiver may comprise: a monitoring device which monitors the level of the emitted light of the above-described light-emitting element, and generates a monitoring signal that indicates the level value thereof; and a monitoring signal transmission device for transmitting, to the control device, the monitoring signal for adjusting the control instruction signal. The monitoring signal transmission device may have a function of outputting the monitoring signal to the control device through the radio communication circuit.

With this, the information transmission state of the optical transceiver can be informed to the control device. The control device transmits the control instruction signal to the optical transceiver in accordance with the monitoring signal. Further, through the structure where the monitoring signal is transmitted to the control device by the radio communication circuit, the same effects as those of the above-described case can be obtained.

Furthermore, the above-described optical transceiver may comprise: an alarm signal emission device which detects changes in the electric current or the voltage in the reception data transmission device or the transmission data input device, and emits an alarm signal when the detected level reaches the reference value; and an alarm signal transmission device for sending out the alarm signal to the control device for adjusting the control instruction signal. The alarm signal transmission device may have a function of outputting the alarm signal to the control device through the radio communication circuit.

With this, the alarm signal can be transmitted to the control device when the information transmission state of the optical transceiver indicates abnormality. The control device transmits the control instruction signal to the optical transceiver in accordance with the alarm signal. Further, through the structure where the alarm signal is transmitted to the control device by the radio communication circuit, the same effects as those of the above-described case can be obtained.

Furthermore, each of the radio communication circuits in the above-described control instruction signal input device, the monitoring signal transmission device, and the alarm signal transmission device of the optical transceiver may be formed with a spatial optical communication circuit which transmits/receives optical signals through the space. It is also possible with this structure to obtain the same effects as those of the above-described case.

Moreover, each of the radio communication circuits in the above-described control instruction signal input device, the monitoring signal transmission device, and the alarm signal transmission device of the optical transceiver may be formed with an optical communication circuit which transmits/receives optical signals through optical fibers. It is also possible with this structure to obtain the same effects as those of the above-described case.

Further, the optical transceiver may comprise a connection/disconnection switching device for switching the connection and disconnection state of the circuit between the reception data transmission device, the transmission data input device, and the control device, based on the control instruction signal inputted through the control instruction input device described above. With such structure, the data communication between the outside and the control device can be controlled in accordance with the communication state.

An optical transceiver operation control method according to an exemplary embodiment of the present invention is a method for controlling the operation of the optical transceiver that is provided with an optical data communication function for converting an optical signal emitted from the outside via an optical communication network into an electric signal and transmitting the electric signal as reception data to a control device through wired communication, while converting the electric signal inputted as transmission data from the control device through the wired communication into the optical signal and emitting it to the outside. The method maybe constituted with: a control instruction signal input step which inputs a control instruction signal for giving an instruction on the control of the operation of the optical transceiver from the control device through radio communication; and a connection/disconnection switching step which switches the connection and disconnection state of a circuit for transmitting the optical signal from the outside to the control device based on the inputted control instruction signal.

Further, an optical transceiver operation control method according to an exemplary embodiment of the present invention is a method for controlling the operation of the optical transceiver that is provided with an optical data communication function which converts an optical signal emitted from the outside via an optical communication network into an electric signal and transmits the electric signal as reception data to a control device through wired communication, while converting the electric signal inputted as transmission data from the control device through the wired communication into the optical signal and emitting it to the outside. The method may be constituted with: a control instruction signal input step which inputs a control instruction signal for giving an instruction on the control of the operation of the optical transceiver from the control device through radio communication; and a connection/disconnection switching step which switches the connection and disconnection state of a circuit for transmitting the electric signal from the control device to the optical communication network based on the inputted control instruction signal.

Furthermore, the optical transceiver operation control method described above may comprise, before the control instruction signal input step: a monitoring step which monitors a level of light emitted to the outside and generates a monitoring signal that indicates the level value thereof; and a monitoring signal transmission step which transmits the monitoring signal to be used for adjusting the control instruction signal to the control device through radio communication.

With the optical transceiver operation control methods described above, the same effects as those of the above-described optical transceiver of the present invention can be obtained.

Explained various embodiments with reference to the drawings, however, the present invention is not limited to the embodiments. They can be changed variously as long as they adhere to a purpose of claims, and also these various changes are included in the claims.

What is claimed is:

1. An optical transmitting/receiving apparatus, comprising:
an optical transceiver which transmits and receives an optical signal to/from outside via an optical fiber;
a control device for controlling the optical transceiver; and
a main signal wiring system and a control wiring system, which are formed between the optical transceiver and the control device, wherein:
the main signal wiring system is constituted with a wired circuit for transmitting a main signal that is an electric signal converted mutually with the optical signal; and
the control wiring system is constituted with a radio circuit for mutually transmitting a monitoring signal that is outputted from the optical transceiver and a control signal that is outputted from the control device based on the monitoring signal for controlling the optical transceiver.

2. The optical transmitting/receiving apparatus as claimed in claim 1, wherein the optical transceiver comprises:
a transmission/reception drive circuit which mutually converts the optical signal and the electric signal to perform optical fiber communication; and
a monitoring device for monitoring a state of the optical transceiver including the transmission/reception drive circuit, wherein:
the transmission/reception drive circuit is connected to the control device via the main signal wiring system that is constituted with the wired circuit; and
the monitoring device is connected to the control device via the control wiring system that is constituted with the radio circuit.

3. The optical transmitting/receiving apparatus as claimed in claim 2, wherein the monitoring device monitors the state of the optical transceiver including the transmission/reception drive circuit based on a change in a temperature, a change in a voltage/electric current, and a change in input/output of the optical signal within the optical transceiver.

4. The optical transmitting/receiving apparatus as claimed in claim 2, wherein the monitoring device monitors the state of the optical transceiver including the transmission/reception drive circuit in real-time.

5. The optical transmitting/receiving apparatus as claimed in claim 1, wherein:
the monitoring device comprises a switching device; and
the switching device connects and disconnects the circuit that is formed with the main signal wiring system between the optical transceiver and the control device.

6. The optical transmitting/receiving apparatus as claimed in claim 2, wherein the monitoring device comprises a memory for storing information that is obtained through monitoring the state of the optical transceiver including the transmission/reception drive circuit.

7. The optical transmitting/receiving apparatus as claimed in claim 1, wherein the control wiring system constituted with the radio circuit performs transmission of the signals in free space.

8. The optical transmitting/receiving apparatus as claimed in claim 1, wherein the control wiring system constituted with the radio circuit performs transmission of the signals through the optical fiber provided in free space.

9. An optical transmitting/receiving apparatus, comprising:
an optical transceiver which transmits and receives an optical signal to/from outside via an optical fiber;
a control means for controlling the optical transceiver; and
a main signal wiring system and a control wiring system, which are formed between the optical transceiver and the control means, wherein:
the main signal wiring system is constituted with a wired circuit for transmitting a main signal that is an electric signal converted mutually with the optical signal; and
the control wiring system is constituted with a radio circuit for mutually transmitting a monitoring signal that is outputted from the optical transceiver and a control signal that is outputted from the control means based on the monitoring signal for controlling the optical transceiver.

10. An optical transmitting/receiving method, comprising:
forming two types of wiring systems, that is, a main signal wiring system constituted with a wired circuit and a control wiring system constituted with a radio circuit, between an optical transceiver for transmitting/receiving an optical signal to/from outside via an optical fiber and a control device for controlling the optical transceiver;
transmitting a main signal that is an electric signal converted mutually with the optical signal, by using the main signal wiring system that is constituted with the wired circuit; and
transmitting a monitoring signal that is outputted from the optical transceiver and a control signal that is outputted from the control device based on the monitoring signal for controlling the optical transceiver, by using the control wiring system that is constituted with the radio circuit.

11. The optical transmitting/receiving method as claimed in claim 10, wherein transmission of the signals is performed in free space by using the control wiring system that is constituted with the radio circuit.

12. The optical transmitting/receiving method as claimed in claim 10, wherein transmission of the signals is performed through the optical fiber provided in free space by using the control wiring system that is constituted with the radio circuit.
